(19) United States
(12) Patent Application Publication
(10) Pub. No.: US 2003/0217973 A1
(43) Pub. Date: Nov. 27, 2003

(54) Method for introducing a sample into a chromatography column

(76) Inventors: Jeffrey A. Horsman, Charlottesville, VA (US); Omar Mneimne, Charlottesville, VA (US); Shahnaz Ghassemi Jamalabadi, Charlottesville, VA (US)

Correspondence Address: FISH & RICHARDSON PC, 225 FRANKLIN ST, BOSTON, MA, 02110, US

(21) Appl. No.: 10/393,674

(22) Filed: Mar. 19, 2003

Related U.S. Application Data
(63) Continuation-in-part of application No. 10/172,466, filed on Jun. 14, 2002.
Application No. 10/172,466 is a continuation of application No. 09/687,801, filed on Oct. 13, 2000, now Pat. No. 6,436,284.
Application No. 09/687,801 is a continuation-in-part of application No. 09/548,261, filed on Apr. 12, 2000, now Pat. No. 6,294,087.
Application No. 09/548,261 is a division of application No. 09/137,278, filed on Aug. 20, 1998, now Pat. No. 6,139,733.
Application No. 09/548,261 is a division of application No. 09/548,214, filed on Apr. 12, 2000, now Pat. No. 6,221,252.
Application No. 09/548,214 is a division of application No. 09/137,278, filed on Aug. 20, 1998, now Pat. No. 6,139,733.

(51) Int. Cl. B01D 15/08

(52) U.S. Cl. 210/656; 210/758; 436/161; 73/61.55

(57) ABSTRACT

Techniques for chromatography, including a method for introducing a sample into a chromatography column having the following steps. A liquid reaction mixture is provided including a sample dissolved in a solvent. A chromatography sample module including a separation media is at least partially immersed in the liquid reaction mixture, such that the liquid reaction mixture is drawn into the sample module by capillary action. The sample module including the sample is inserted into a chromatography column.

### REFERENCE TO RELATED APPLICATIONS

This application is a continuation-in-part of U.S. patent Ser. No. 10/712,466, filed on Jun. 14, 2002, which is a continuation of U.S. patent Ser. No. 09/687,801, filed Oct. 13, 2000 (now U.S. Pat. No. 6,436,284), which is a continuation-in-part of U.S. patent Ser. No. 09/548,261 filed Apr. 12, 2000 (now U.S. Pat. No. 6,294,087), which is a divisional application of U.S. pat. Ser. No. 09/137,278 filed Aug. 20, 1998 (now U.S. Pat. No. 6,139,733), and a continuation-in-part of U.S. patent Ser. No. 09/548,214 filed Apr. 12, 2000 (now U.S. Pat. No. 6,221,252), which is a divisional application of U.S. patent Ser. No. 09/137,278 filed Aug. 20, 1998 (now U.S. Pat. No. 6,139,733). This application claims priority from each of the above-referenced applications, each of which is incorporated herein by reference.

### BACKGROUND OF THE INVENTION

The invention relates to introducing a sample into a chromatography column.

Liquid chromatography is a technique for separating the individual compounds that exist in a subject sample. In employing the technique, the sample is carried in a liquid, called a mobile phase. The mobile phase carrying the sample is caused to migrate through a media, sometimes called a stationary phase. Different compounds will have differing rates of migration through the media, which effects the separation of the components in the subject sample. Liquid chromatography is commonly performed with reusable columns or with disposable cartridges, both of which are usually cylindrical, in which the media bed is bounded axially by porous plates, or plates containing defined flow paths, through which the mobile phase will flow. (See U.S. Pat. No. 4,250,035 to McDonald et al.)

To optimize liquid chromatographic separation conditions, it may be necessary to dissolve the sample in a dissolution solvent, which may be non-ideal for elution. This can result in poor separation and poor recovery of desired components. One solution to this problem is to pre-absorb the sample onto a media prior to chromatography. This can involve dissolving the sample in a suitable solvent and adding an amount of a dry media (usually similar to the media being used for the separation) to this solution. The dissolution solvent is then removed, for example, using a rotary evaporator, leaving the sample mixture dry, and adsorbed to the media. The pre-adsorbed sample is then placed at the head of a pre-packed chromatography column, and the optimized chromatographic solvent flows through the pre-adsorbed media and then through the column of separation media. This method has the potential hazard of the operator coming into contact with the dry, powdery media both before and after the addition of the sample. This method can also lead to poor separation and recovery.

Another approach is to dissolve the sample in a suitable solvent, thereby forming a liquid reaction mixture, and pouring the liquid reaction mixture into a chromatography sample module containing a separation media. A sample module can be a tubular member sized to fit within the end of a chromatography column that is used for purification of the sample, or can be connected to the chromatography separation column by a flow line (See U.S. Pat. No. 6,139,733 to Hargro et al). The sample module can then be dried to remove the solvent, leaving the sample absorbed onto the separation media. The optimized chromatographic solvent then flows into the sample module and the effluent from the sample module is directed into a chromatography column containing a separation media, which may or may not be the same as the separation media used in the sample module.

This approach requires the handling of liquids by the operator, which can lead to spillage and unsafe conditions, such as skin contact with a spilled liquid reaction mixture, and the introduction of impurities into the liquid. Additionally, the liquid reaction mixture typically requires scavenging to remove excess acid or base, or other reactants or products included in the solvent, prior to separation by the chromatography column.

Scavenging an acid, for example, can be done using water containing a base. The water is added to the water immiscible liquid reaction mixture, which is then shaken and allowed to separate. The water layer is removed and shaken with additional water immiscible solvent, and allowed to separate, forming a second water layer and a second solvent layer. The second water layer is discarded and the second solvent layer is retained. The solvent layer from the original mixture is shaken with additional water containing a base and allowed to separate, forming a third water layer and a third solution layer. The third water layer is discarded, and the third solvent layer is retained. The two retained solvent layers are then pooled and dried with a desiccant to remove any entrained water, and then filtered to remove the desiccant. The solution requires concentrating to reduce the volume and may then be poured into the sample module.

Another method to scavenge involves adding a solid scavenger resin into the liquid reaction mixture, stirring for a certain length of time (often several hours) and then filtering off the scavenger resin. The solid scavenger resin filtered from the liquid reaction mixture is washed with additional solvent. The resulting solid scavenger resin is discarded and the solvent wash is retained. The filtered liquid reaction mixture is pooled with the solvent wash, and then concentrated to reduce the volume before being poured into the sample module.

The above methods require a number of steps involving the handling of liquids by the operator, which can lead to spillage and unsafe conditions, as described above. Further, these techniques for scavenging can be costly in terms of time and excess solvent, and as such are less environmentally friendly.

### SUMMARY OF THE INVENTION

The present invention provides techniques for chromatography. In general, in one aspect, the invention features a method for introducing a sample into a chromatography column, including the following steps. A liquid reaction mixture is provided including a sample dissolved in a solvent. A chromatography sample module including a separation media is at least partially immersed in the liquid reaction mixture, such that the liquid reaction mixture is drawn into the sample module by capillary action. The sample module including the sample is inserted into a chromatography column.

Implementations of the invention can include one or more of the following. The liquid reaction mixture can be wicked upwardly into the sample module. The sample module can further include scavenger media, and the method can include the further step of scavenging an acid, base, reactant or product from the liquid reaction mixture by drawing the liquid reaction mixture into the sample module by capillary action, such that the scavenged acid, base, reactant or product attaches to the scavenger media. The method can include the further step of removing the solvent from the sample module before inserting the sample module into the chromatography column. Removing the solvent can include placing the sample module in a vacuum chamber, and heat can be applied to the vacuum chamber.

In general, in another aspect, the invention features a method for introducing a sample into a chromatography column, including the following steps. A liquid reaction mixture including a sample dissolved in a solvent is provided, and a chromatography sample module including a separation media is at least partially immersed in the liquid reaction mixture. The liquid reaction mixture is drawn into the sample module by capillary action. The sample module including the sample is inserted into a remote holder coupled to a chromatography column.

Implementations of the invention can include one or more of the following. The remote holder can be sealed and includes an inlet and an outlet such that solvent can be flowed through the remote holder and an effluent from the remote holder can be directed into the chromatography column. The sample module can further include scavenger media, and the method can include the further step of scavenging an acid, base, reactant or product from the liquid reaction mixture by drawing the liquid reaction mixture into the sample module by capillary action, such that the scavenged acid, base, reactant or product attaches to the scavenger media.

The method can include the further step of removing the solvent from the sample module before inserting the sample module into the remote holder. Removing the solvent can include placing the sample module in a vacuum chamber, and heat can be applied to the vacuum chamber. The liquid reaction mixture can be wicked upwardly into the sample module.

The invention can be implemented to realize one or more of the following advantages. Immersing the samplet into the liquid reaction mixture avoids at least one step of liquid handling by the operator. Liquid handling can lead to spillage and unsafe conditions, such skin contact with spilled substances. Liquid handling can also introduce impurities by cross-contamination into the liquid and lead to poor recoveries. By including a scavenger media in the samplet, scavenging occurs simultaneously with the separation of the sample from the solvent in the liquid reaction mixture. The technique is faster, uses less solvent, is more environmentally friendly and the operator avoids tedious and time-consuming techniques of scavenging described above.

### BRIEF DESCRIPTION OF THE DRAWINGS

FIG. 1A is a schematic diagram of a chromatography system including a sample module inserted into a chromatography column.

FIG. 1B is a schematic diagram of a chromatography system including a sample module inserted into a remote holder.

FIGS. 2A, 2B and 2C are vertical sectional views of chromatography sample modules used in the FIGS. 1A and 1B systems.

FIG. 3A is a vertical sectional view showing a FIG. 2A sample module in position between a sealing head and a chromatography column used in the FIG. 1A system prior to assembly.

FIG. 3B is a vertical sectional view showing a FIG. 2A sample module in position between a sealing head and a remote holder used in the FIG. 1B system prior to assembly.

FIG. 4A is a vertical sectional view showing the FIG. 3A components in an assembled and sealed state.

FIG. 4B is a vertical sectional view showing the FIG. 3B components in an assembled and sealed state.

FIG. 5 is a flowchart showing a process for introducing a sample into a chromatography column.

### DETAILED DESCRIPTION

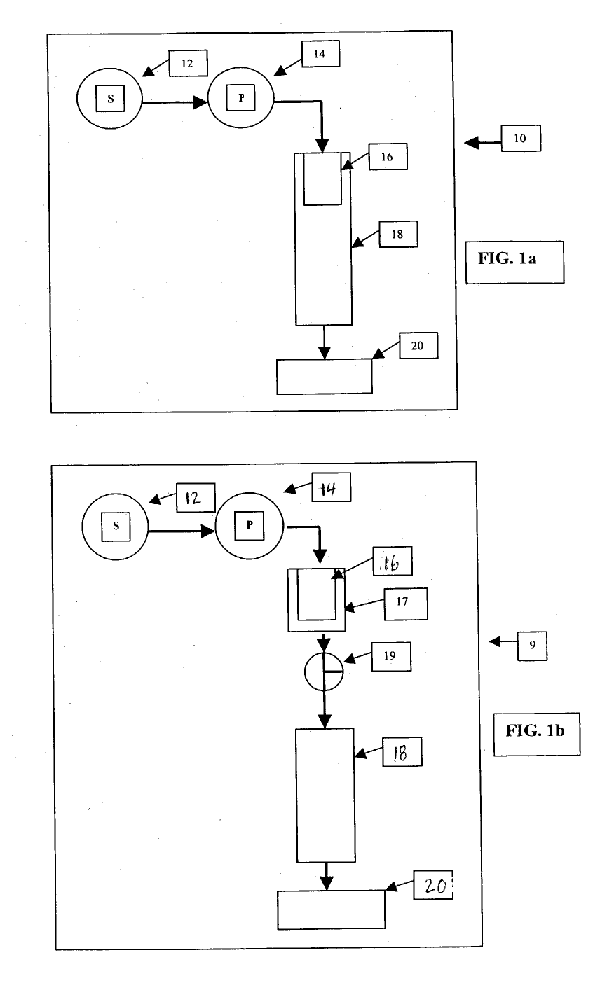

Referring to FIG. 1A, there is shown a chromatography system 10, which includes a source of solvent 12, a pump 14, a sample module 16 shown inserted into a chromatography column 18, and a sample collection vessel 20. In this system, the sample to be purified is pre-absorbed onto media in the sample module 16 and inserted into the chromatography column 18, prior to pumping the solvent 12 through the sample module 16 and into the chromatography column 18 to perform the purification process.

Referring to FIG. 1B, there is shown a chromatography system 9, which includes a source of solvent 12, a pump 14, a sample module 16 shown inserted into a remote holder 17 connected to a chromatography column 18 via a three-way valve 19, and a sample collection vessel 20. In this system 9, the sample to be purified is pre-absorbed onto media in the sample module 16, which module 16 is inserted into the remote holder 17. An outlet from the remote holder 17 can be connected to the chromatography column 18 directly by a solvent tube or via a three-way valve 19, as shown. The three-way valve 19 can be used to switch the chromatography column 18 out of the flow path temporarily, to quickly flush off eluting impurities from the sample module 16. This procedure removes unwanted impurities from the sample module 16, prior to pumping the solvent 12 through the sample module 16 and into the chromatography column 18 to perform the purification procedure. Removing the unwanted impurities reduces the effective loading on the chromatography column 18, thereby increasing the column's efficiency and performance.

The sample module 16 of FIGS. 1A and 1B can be a sample module as described in U.S. Pat. No. 6,139,733 to Hargro et al, and can be used as described in U.S. Pat. No. 6,221,252 to Hargro et al, the entire contents of which patents are hereby incorporated by reference.

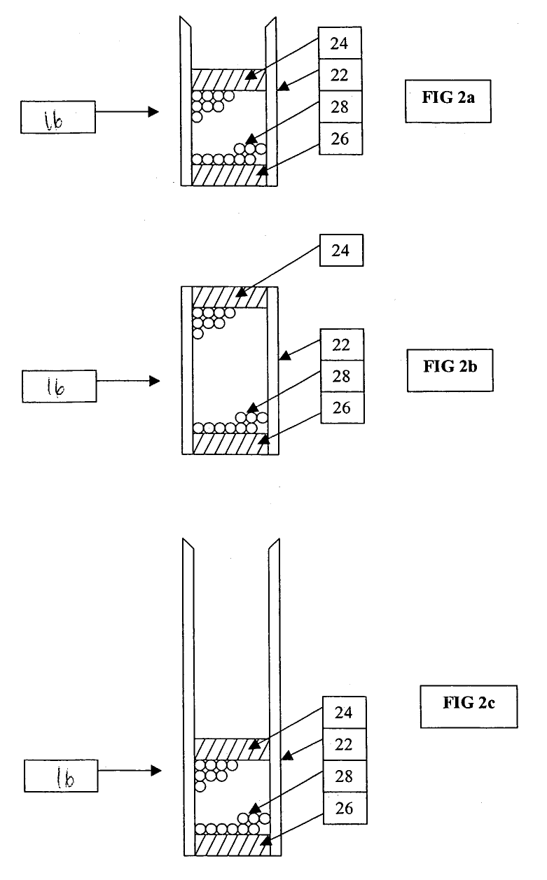

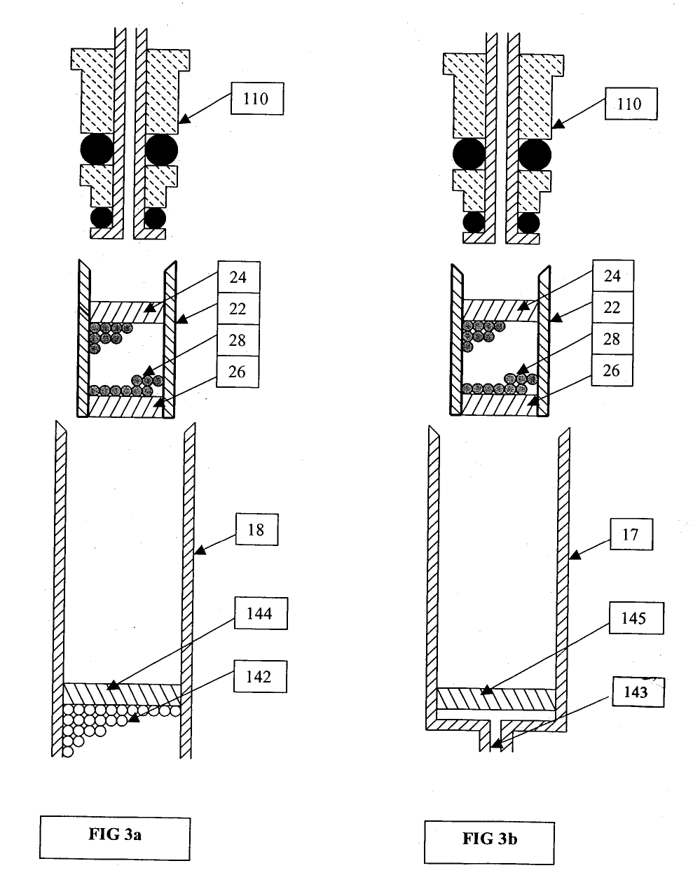

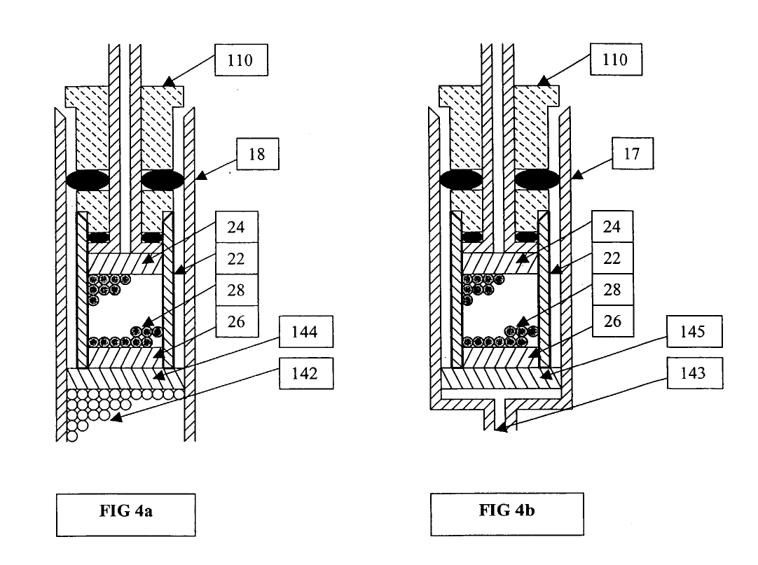

Referring to FIGS. 2A, 2B and 2C, examples of sample module 16 are shown, each including a cylindrical plastic tube 22, upper and lower porous plates 24, 26 (made of inert plastic porous frits), and chromatography media 28 between the porous plates 24, 26. As shown in FIGS. 3A and 4A, the sample module 16 can be configured to fit within a chromatography column 18 at the entrance thereof and to be sealably connected to a sealing head 110. Alternatively, as shown in FIGS. 3B and 4B, the sample module 16 can be configured to fit into a remote holder 17. In both instances, the sample module 16 is held in the fluid path thereof and is sealably connected to sealing heads 110. The tube 22 is designed to fit within the column 18 or remote holder 17 with minimal space between the two, for example, a radial clearance in the range of 0.000″ to 0.010″. Other suitable sample modules designed to fit within the chromatography column 18 or another suitable chromatography column can also be used.

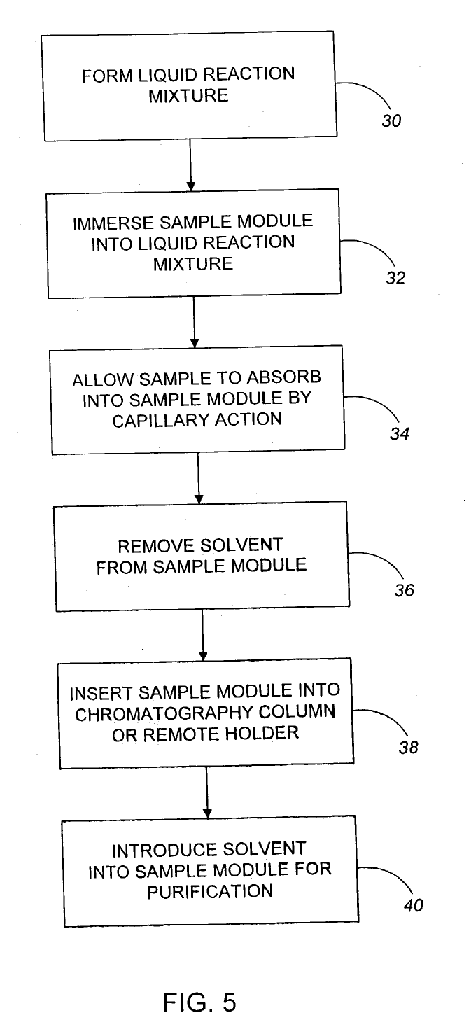

FIG. 5 shows a process for introducing a sample into the chromatography column 18 using the sample module 16. The sample is first dissolved in a solvent, thereby forming a liquid reaction mixture (Step 30). The sample module 16 is immersed into the liquid reaction mixture, which can be contained in a reaction flask or other suitable container (Step 32). The sample module 16 includes a separation media, and can also include a scavenger media, discussed further below. The liquid reaction mixture wicks up into the sample module 16 by capillary action (Step 34). The sample absorbs into the separation media in the sample module 16, thereby separating the sample from the solvent. The solvent is then removed (Step 36), for example, by placing the sample module 16 in a vacuum chamber. Heat can also be applied.

After the sample module 16 has dried, it can be inserted directly inside the chromatography column 18 or remote holder 17 (Step 38) for purification. As shown in FIG. 4A, the sample module 16 is positioned within the chromatography column 18 such that the lower porous plate 26 is in intimate contact with a porous plate 144 within the chromatography column 18 on top of the separation media 142. The sample module 16 can be sealed with sealing head 110.

Alternatively, as shown in FIG. 4B, the sample module 16 can be placed in a remote holder 17 and positioned within the remote holder 17 such that the lower porous plate 26 is in intimate contact with a porous plate 145 of the remote holder 17, and can be sealed with sealing head 110. The remote holder 17 can then be connected to the solvent pump 12 (FIG. 1B) via the sealing head 110. Solvent tubing connects an outlet 143 of the remote holder 17 (FIG. 3B) to the chromatography column 18 inlet. Alternatively, the outlet 143 of the remote holder 17 and the chromatography column 18 can be connected via a three-way valve 19, as shown in FIG. 1B. The three-way valve 19 allows unwanted effluent to be removed from the sample module 16 when the chromatography column 18 is switched out of the flow path. Once the unwanted effluent has been removed, the chromatography column 18 can be switched back into the flow path, using the three-way valve 19, and separation through the chromatography column 18 can be achieved. An example of a remote holder 17 is a Zero Insertion Force—Sample Injection Module (ZIF-SIM™) available from Biotage, Inc., a Dyax Corp. company, of Charlottesville, Va.

Referring again to FIG. 5, after inserting sample module 16 into chromatography column or remote holder (Step 38), suitable solvent is then passed through the chromatography column 18 including the sample module 16, separating the components therein based on the affinity for each to either stay with the solid phase (separation media 144) of the column 18 or move through with the solvent 12 (Step 40).

By immersing the sample module 16 into the liquid reaction mixture, the operator avoids pouring the liquid reaction mixture into the top of the sample module 16, thereby eliminating at least one step of liquid handling. The sample module 16 can be immersed in the liquid reaction mixture for any period of time required to fully wick up the liquid reaction mixture into the sample module 16. The time period required varies with the amount of liquid reaction mixture, but typically is in the range of approximately five minutes, although it could be a longer or shorter duration.

The sample module 16 can also include a scavenger media. As discussed above, the liquid reaction mixture typically requires scavenging to remove excess acid or base included in the solvent. By including a scavenger media in the sample module 16, the excess acid or base can be scavenged when the sample is wicked up into the sample module by capillary action. The scavenged substance attaches to the scavenger media and remains attached during and after the purification step. This scavenging technique eliminates the time-consuming and tedious scavenging process described above, including several steps involving potentially unsafe liquid handling.

The invention has been described in terms of particular embodiments. Other embodiments are within the scope of the following claims.

What is claimed is:

1. A method for introducing a sample into a chromatography column, the method comprising:
providing a liquid reaction mixture including a sample dissolved in a solvent;
at least partially immersing a chromatography sample module including a separation media in the liquid reaction mixture, such that the liquid reaction mixture is drawn into the sample module by capillary action; and
inserting the sample module including the sample into a chromatography column.

2. The method of claim 1, wherein the sample module further includes scavenger media, the method further comprising:
scavenging an acid from the liquid reaction mixture by drawing the liquid reaction mixture into the sample module by capillary action, such that the scavenged acid attaches to the scavenger media.

3. The method of claim 1, wherein the sample module further includes scavenger media, the method further comprising:
scavenging a base from the liquid reaction mixture by drawing the liquid reaction mixture into the sample module by capillary action, such that the scavenged base attaches to the scavenger media.

4. The method of claim 1, wherein the sample module further includes scavenger media, the method further comprising:
scavenging a reactant from the liquid reaction mixture by drawing up the liquid reaction mixture into the sample module by capillary action, such that the scavenged reactant attaches to the scavenger media.

5. The method of claim 1, wherein the sample module further includes scavenger media, the method further comprising:
scavenging a product from the liquid reaction mixture by drawing up the liquid reaction mixture into the sample module by capillary action, such that the scavenged product attaches to the scavenger media.

6. The method of claim 1, further comprising:
removing the solvent from the sample module before inserting the sample module into the chromatography column.

7. The method of claim 6, wherein removing the solvent includes placing the sample module in a vacuum chamber.

8. The method of claim 7, further comprising, applying heat to the vacuum chamber.

9. The method of claim 1, wherein the liquid reaction mixture is wicked upwardly into the sample module.

10. A method for introducing a sample into a chromatography column, the method comprising:
providing a liquid reaction mixture including a sample dissolved in a solvent;
at least partially immersing a chromatography sample module including a separation media in the liquid reaction mixture, such that the liquid reaction mixture is drawn into the sample module by capillary action; and
inserting the sample module including the sample into a remote holder coupled to a chromatography column.

11. The method of claim 10, wherein the remote holder can be sealed and includes an inlet and an outlet such that solvent can be flowed through the remote holder and an effluent from the remote holder can be directed into the chromatography column.

12. The method of claim 10, wherein the sample module further includes scavenger media, the method further comprising:
scavenging an acid from the liquid reaction mixture by drawing the liquid reaction mixture into the sample module by capillary action, such that the scavenged acid attaches to the scavenger media.

13. The method of claim 10, wherein the sample module further includes scavenger media, the method further comprising:
scavenging a base from the liquid reaction mixture by drawing up the liquid reaction mixture into the sample module by capillary action, such that the scavenged base attaches to the scavenger media.

14. The method of claim 10, wherein the sample module further includes scavenger media, the method further comprising:
scavenging a reactant from the liquid reaction mixture by drawing up the liquid reaction mixture into the sample module by capillary action, such that the scavenged reactant attaches to the scavenger media.

15. The method of claim 10, wherein the sample module further includes scavenger media, the method further comprising:
scavenging a product from the liquid reaction mixture by drawing up the liquid reaction mixture into the sample module by capillary action, such that the scavenged product attaches to the scavenger media.

16. The method of claim 10, further comprising:
removing the solvent from the sample module before inserting the sample module into the remote holder.

17. The method of claim 16, wherein removing the solvent includes placing the sample module in a vacuum chamber.

18. The method of claim 17, further comprising, applying heat to the vacuum chamber.

19. The method of claim 10, wherein the liquid reaction mixture is wicked upwardly into the sample module.
